(19) United States
(12) Patent Application Publication
(10) Pub. No.: US 2003/0218336 A1
(43) Pub. Date: Nov. 27, 2003

(54) Pipe coupling for connecting pipe members

(76) Inventor: Sigeyuki Ito, Yokohama-shi (JP)

Correspondence Address: JACOBSON HOLMAN PLLC, 400 SEVENTH STREET N.W., SUITE 600, WASHINGTON, DC, 20004, US

(21) Appl. No.: 10/408,678

(22) Filed: Apr. 8, 2003

(30) Foreign Application Priority Data
Apr. 9, 2002 (JP) 2002-140794

(51) Int. Cl. F16L 17/00

(52) U.S. Cl. 285/370

(57) ABSTRACT

The present invention can provide a regular and unnoticeable connection since a pipe member is inserted and adhered into a joint having a diameter substantially equal to that of the pipe member. The present invention can also facilitate the connection work with low cost. The present invention can further simply couple pipe members to each other at an angle at which it is difficult to machine the pipe members and also connect complicatedly bent pipe members to each other.

### BACKGROUND OF THE INVENTION

The present invention relates to a pipe coupling for connecting pipe members such as balcony handrails, stairs handrails, interior decoration shelves, safety guards, building frameworks, article shelves, storerooms, ship chandleries and sports equipment.

In the coupling of pipe members such as screwed water service pipes according to the prior art, the connection was noticeable and defaced since it has an external diameter larger than those of the pipe members.

In connection of the pipe members, they were machined by ironworker engineers. This required screw cutting lathes, leading to increase in the manufacturing cost. Since the machined surfaces of the connecting sections are irregular, resulting in complexity of the connecting operations.

If the pipe members have been galvanized, the machined portions must be re-galvanized.

Furthermore, it was difficult to couple pipe members to each other at an angle at which it was difficult to machine the pipe members and also to connect bent pipe members to each other.

An object of the present invention is to provide a pipe coupling which can eliminate any noticeable irregularity in the connection between pipe members, which can easily connect pipe members with reduced manufacturing cost and which can simply couple pipe members to each other at an angle at which it is difficult to machine the pipe members and also connect complicatedly bent pipe members to each other.

### SUMMARY OF THE INVENTION

In a first aspect of the present invention, a pipe coupling comprises two joints each of which has a diameter substantially equal to an internal diameter of a pipe member to be coupled and extending in the straight line and wherein two pipe members are inserted and adhered into the ends of the respective joints to form a straight pipe.

In a second aspect of the present invention, a pipe coupling comprises two joints each having a diameter substantially equal to an internal diameter of a pipe member to be coupled and being interconnected at an angle of 90 degrees and wherein a pipe member is inserted and adhered at one end into each joint to form an elbow pipe.

In a third aspect of the present invention, a pipe coupling comprises three joints each having a diameter substantially equal to an internal diameter of a pipe member to be coupled and being interconnected to form a substantially T-shaped configuration and wherein a pipe member is inserted and adhered at one end into each joint to form a T-pipe consisting of straight and elbow pipes.

In a fourth aspect of the present invention, a pipe coupling comprises three joints each having a diameter substantially equal to an internal diameter of a pipe member to be coupled, one of these joints extending in the horizontal direction while the remaining two joints being interconnected at an angle of 90 degrees in the vertical direction and wherein one end of a pipe member is inserted and adhered into each joint to form a pipe assembly consisting of horizontal and elbow pipes.

In a fifth aspect of the present invention, a pipe coupling comprises two joints each having a diameter substantially equal to an internal diameter of a pipe member to be coupled, one of these joints extending in the straight line while the other joint being connected with the one joint at an angle of 45 degrees relative to said straight line and wherein a pipe member is inserted and adhered into each joint to form a 45-degree bent pipe.

In a sixth aspect of the present invention, a pipe coupling comprises three joints each having a diameter substantially equal to an internal diameter of a pipe member to be coupled, one of these joints extending in the straight line of the horizontal direction, another joint being connected with the one joint at an angle of 45 degrees relative to the straight line and the remaining joint being connected with the above-mentioned joints at an angle of 90 degrees relative to the horizontal plane said in the vertical direction and wherein a pipe member is inserted and adhered into each joint to form a pipe assembly consisting of 45-degree bent and horizontal pipes.

In a seventh aspect of the present invention, a pipe coupling comprises three joints each having a diameter substantially equal to an internal diameter of a pipe member to be coupled, two of these joints extending in the straight line while the remaining joint being connected with the two joints at an angle of 45 degrees relative to said straight line and wherein a pipe member is inserted and adhered into each joint to form straight and 45-degree bent pipes.

In a eighth aspect of the present invention, a pipe coupling comprises four joints each having a diameter substantially equal to an internal diameter of a pipe member to be coupled, one of these joints extending in the horizontal direction, two of these joints being interconnected at an angle of 90 degrees in the vertical direction, and the remaining one joint being connected at an angle of 45 degrees relative to one of said two joints and wherein a pipe member is inserted and adhered into each joint to form a pipe assembly consisting of straight, 45-degree bent and horizontal pipes.

In a ninth aspect of the present invention, a pipe coupling comprises four joints each having a diameter substantially equal to an internal diameter of a pipe member to be coupled, two of these joints extending in the straight line, one of the remaining two joints being connected at an angle 90 degrees relative to said straight line, and the other of the remaining two joints being connected at an angle of 45 degrees relative to said straight line and wherein a pipe member is inserted and adhered into each joint to form a pipe assembly consisting of straight, 45-degree bent and horizontal pipes.

In a tenth aspect of the present invention, a pipe coupling comprises two joints each having a diameter substantially equal to an internal diameter of a pipe member to be coupled, one of these joints extending in the straight line while the other joint being connected with the one joint at an angle of 135 degrees relative to said straight line and wherein a pipe member is inserted and adhered into each joint to form a 135-degree bent pipe.

In a eleventh aspect of the present invention, a pipe coupling comprises three joints each having a diameter substantially equal to an internal diameter of a pipe member to be coupled, one of these joints extending in the straight line of the horizontal direction, another joint being connected with the one joint at an angle of 135 degrees relative to said straight line, and the remaining joint being connected with the above-mentioned joints at an angle of 90 degrees in the vertical direction and wherein a pipe member is inserted and adhered into each joint to form a pipe assembly consisting of 135-degree bent and horizontal pipes.

In a twelfth aspect of the present invention, a pipe coupling comprises five joints each having a diameter substantially equal to an internal diameter of a pipe member to be coupled, two of these joints extending in the straight line of the horizontal direction, one of the remaining two joints extends with an angle 90 degrees relative in said straight line of said horizontal direction while the other joint extends with an angle of 45 degrees relative to said straight line and the final joint being connected with the above-mentioned joints at an angle of 90 degrees relative to the horizontal plane in the vertical direction and wherein a pipe member is inserted and adhered into each joint to form a pipe assembly consisting of straight, 45-degree bent, horizontal and vertical pipes.

In a thirteenth aspect of the present invention, a pipe coupling has a portion for connecting a rainwater protection member, a dust protection member or a lighting member.

In a fourteenth aspect of the present invention, a pipe coupling has a portion for fixing a corner of a pipe member.

In a fifteenth aspect of the present invention, a pipe coupling comprises four joints each having a diameter substantially equal to an internal diameter of a pipe member to be coupled, one of these joints extending in the horizontal plane of the horizontal direction, two of these joints extending in the straight line in the vertical direction, and the remaining one joint being connected at an angle of 90 degrees relative to said straight line and wherein a pipe member is inserted and adhered into each joint to form a pipe assembly consisting of straight, 90-degree bent and horizontal pipes.

In a sixteenth aspect of the present invention, a pipe coupling comprises two or more joints into each of which the corresponding one of two or more pipe members different in internal diameter from each other is inserted and adhered.

### BRIEF DESCRIPTION OF THE DRAWINGS

FIG. 1 is a front sectional view illustrating pipe members coupled using pipe couplings according to the first embodiment of the present invention.

FIG. 2 is a top sectional view of FIG. 1.

FIG. 3 is a front sectional view illustrating pipe members coupled using pipe couplings according to the second embodiment of the present invention.

FIG. 4 is a top sectional view of FIG. 3.

FIG. 5 is a front sectional view illustrating pipe members coupled using pipe couplings according to the third embodiment of the present invention.

FIG. 6 is a top sectional view of FIG. 5.

### DETAILED DESCRIPTION

Several embodiments of the present invention will now be described with reference to the accompanying drawings while comparing with the prior art. In the drawings, an alphabetic character A designates pipe members that are made from metal, such as stainless steel, and grayed parts indicate pipe couplings and their joints and represent the internal structures in the pipe members A.

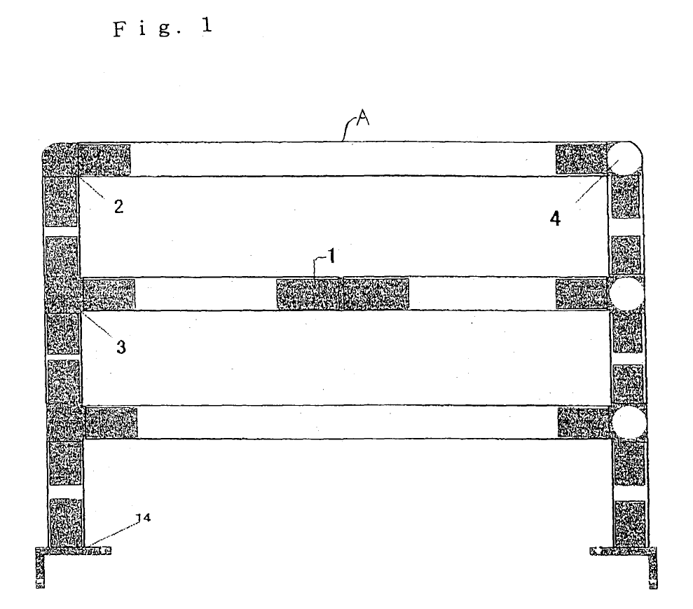

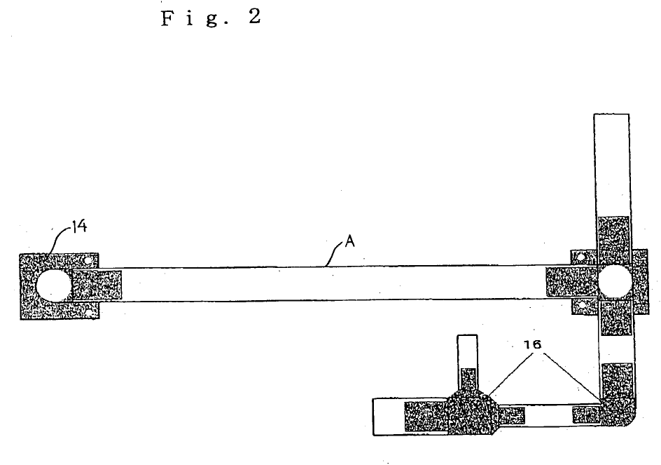

FIG. 1 is a front sectional view illustrating pipe members coupled using pipe couplings according to the first embodiment of the present invention. FIG. 2 is a top sectional view of FIG. 1.

Reference numeral 1 denotes a pipe coupling comprising two joints each of which has an internal diameter substantially equal to an internal diameter of a pipe member A. Two pipe members A are inserted and adhered with adhesives into the ends of the respective joints to form a straight pipe.

Reference numeral 2 designates a pipe coupling which comprises two joints each having a diameter substantially equal to an internal diameter of a pipe member A and being interconnected at an angle of 90 degrees. A pipe member A is inserted and adhered with adhesives at one end into each joint to form an elbow pipe.

Reference numeral 3 shows a pipe coupling which comprises three joints each having a diameter substantially equal to an internal diameter of a pipe member A and being interconnected to form a substantially T-shaped configuration. A pipe member A is inserted and adhered with adhesives at one end into each joint to form a T-pipe consisting of straight and elbow pipes.

Reference numeral 4 indicates a pipe coupling which comprises three joints each having a diameter substantially equal to an internal diameter of a pipe member A, one of these joints extending in the horizontal direction while the remaining two joints being interconnected at an angle of 90 degrees in the vertical direction. One end of a pipe member A is inserted and adhered with adhesives into each joint to form a pipe assembly consisting of horizontal and elbow pipes.

Reference numeral 14 denotes a pipe coupling having a portion for fixing a corner.

Reference numeral 16 designates a pipe coupling comprising two or more joints into each of which the corresponding one of two or more pipe members A different in internal diameter from each other is inserted and adhered with adhesives.

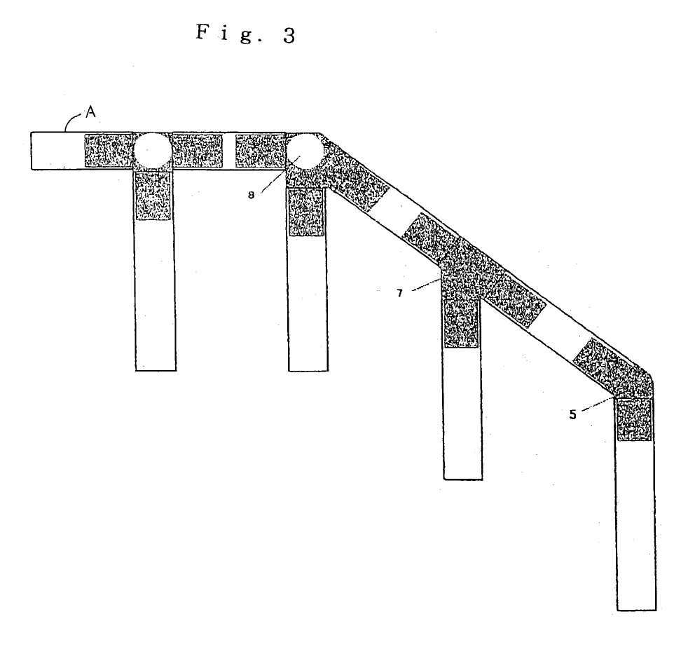

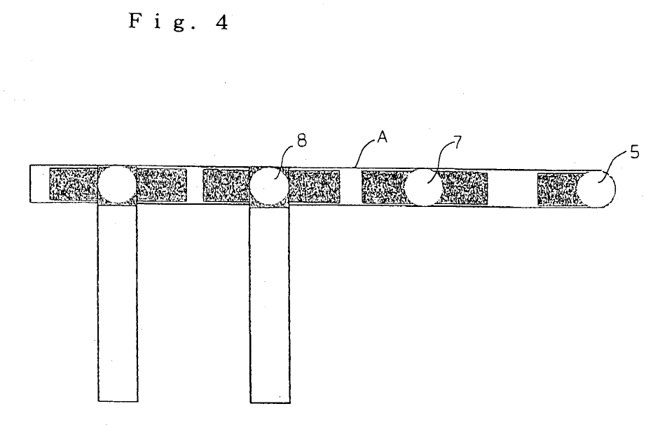

FIG. 3 is a front sectional view illustrating pipe members coupled using pipe couplings according to the second embodiment of the present invention. FIG. 4 is a top sectional view of FIG. 3.

Reference numeral 5 indicates a pipe coupling which comprises two joints each having a diameter substantially equal to an internal diameter of a pipe member A, one of these joints extending in the horizontal direction while the other joint being connected with the one joint at an angle of 45 degrees in the same plane. A pipe member A is inserted and adhered with adhesives into each joint to form a 45-degree bent pipe.

Reference numeral 7 shows a pipe coupling which comprises three joints each having a diameter substantially equal to an internal diameter of a pipe member A, two of these joints extending in the horizontal direction while the remaining joint being connected with the two joints at an angle of 45 degrees in the same plane. A pipe member A is inserted and adhered with adhesives into each joint to form a 45-degree bent pipe.

Reference numeral 8 designates a pipe coupling which comprises four joints each having a diameter substantially equal to an internal diameter of a pipe member A. One of these joints extends in the horizontal direction; two of these joints are interconnected at an angle of 90 degrees in the vertical direction; and the remaining one joint is connected with the first-mentioned joints at an angle of 45 degrees. A pipe member A is inserted and adhered with adhesives into each joint to form a pipe assembly consisting of straight, 45-degree bent and horizontal pipes.

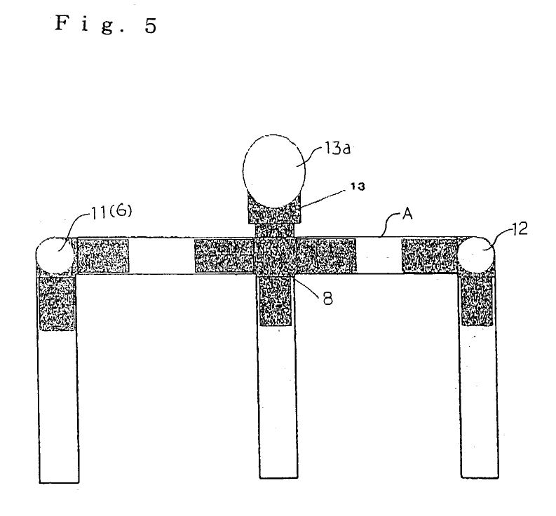

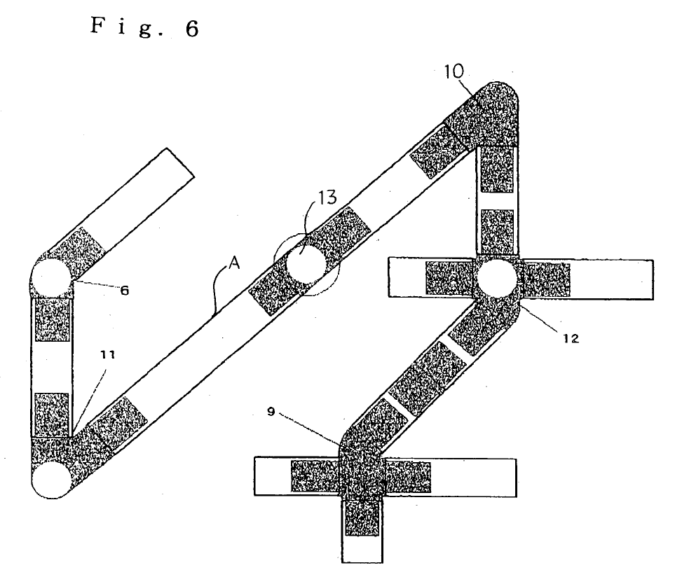

FIG. 5 is a front sectional view illustrating pipe members coupled using pipe couplings according to the third embodiment of the present invention. FIG. 6 is a top sectional view of FIG. 5.

Reference numeral 9 indicates a pipe coupling which comprises four joints each having a diameter substantially equal to an internal diameter of a pipe member A. Two of these joints extend in the horizontal direction; one of the remaining two joints extends in the horizontal direction; and the other of the remaining two joints is connected with the above-mentioned joints in the same plane at an angle of 45 degrees. A pipe member A is inserted and adhered with adhesives into each joint to form a pipe assembly consisting of straight, 45-degree bent and horizontal pipes.

Reference numeral 10 shows a pipe coupling which comprises two joints each having a diameter substantially equal to an internal diameter of a pipe member A, one of these joints extending in the horizontal direction while the other joint being connected with the one joint at an angle of 135 degrees in the same plane. A pipe member A is inserted and adhered with adhesives into each joint to form a 135-degree bent pipe.

Reference numeral 11 indicates a pipe coupling which comprises three joints each having a diameter substantially equal to an internal diameter of a pipe member A. One of these joints extends in the horizontal direction; another joint is connected with the one joint at an angle of 135 degrees; and the remaining joint is connected with the above-mentioned joints at an angle of 90 degrees. A pipe member A is inserted and adhered with adhesives into each joint to form a pipe assembly consisting of 135-degree bent and horizontal pipes.

Reference numeral 12 denotes a pipe coupling which comprises five joints each having a diameter substantially equal to an internal diameter of a pipe member A. Two of these joints extend in the horizontal direction. One of the remaining two joints extends in the horizontal direction while the other joint extends with an angle of 45 degrees relative to said one joint in the same plane. The final joint is connected with the above-mentioned joints in the vertical direction at an angle of 90 degrees relative to the horizontal plane.

Reference numeral 13 shows a pipe coupling having a portion for connecting a rainwater- or dust-protection member or a lighting member 13a.

The present invention can provide a regular and unnoticeable connection since a pipe member is inserted and adhered into a joint having a diameter substantially equal to that of the pipe member. The present invention can also facilitate the connection work with low cost. The present invention can further simply couple pipe members to each other at an angle at which it is difficult to machine the pipe members and also connect complicatedly bent pipe members to each other.

1. A pipe coupling comprising two joints each of which has a diameter substantially equal to an internal diameter of a pipe member to be coupled and extending in the straight line and wherein two pipe members are inserted and adhered into the ends of the respective joints to form a straight pipe.

2. A pipe coupling comprising two joints each having a diameter substantially equal to an internal diameter of a pipe member to be coupled and being interconnected at an angle of 90 degrees and wherein a pipe member is inserted and adhered at one end into each joint to form an elbow pipe.

3. A pipe coupling comprising three joints each having a diameter substantially equal to an internal diameter of a pipe member to be coupled and being interconnected to form a substantially T-shaped configuration and wherein a pipe member is inserted and adhered at one end into each joint to form a T-pipe consisting of straight and elbow pipes.

4. A pipe coupling comprising three joints each having a diameter substantially equal to an internal diameter of a pipe member to be coupled, one of these joints extending in the horizontal direction while the remaining two joints being interconnected at an angle of 90 degrees in the vertical direction and wherein one end of a pipe member is inserted and adhered into each joint to form a pipe assembly consisting of horizontal and elbow pipes.

5. A pipe coupling comprising two joints each having a diameter substantially equal to an internal diameter of a pipe member to be coupled, one of these joints extending in the straight line while the other joint being connected with the one joint at an angle of 45 degrees relative to said straight line and wherein a pipe member is inserted and adhered into each joint to form a 45-degree bent pipe.

6. A pipe coupling comprising three joints each having a diameter substantially equal to an internal diameter of a pipe member to be coupled, one of these joints extending in the straight line of the horizontal direction, another joint being connected with the one joint at an angle of 45 degrees relative to the straight line and the remaining joint being connected with the above-mentioned joints at an angle of 90 degrees relative to the horizontal plane said in the vertical direction and wherein a pipe member is inserted and adhered into each joint to form a pipe assembly consisting of 45-degree bent and horizontal pipes.

7. A pipe coupling comprising three joints each having a diameter substantially equal to an internal diameter of a pipe member to be coupled, two of these joints extending in the straight line while the remaining joint being connected with the two joints at an angle of 45 degrees relative to said straight line and wherein a pipe member is inserted and adhered into each joint to form straight and 45-degree bent pipes.

8. A pipe coupling comprising four joints each having a diameter substantially equal to an internal diameter of a pipe member to be coupled, one of these joints extending in the horizontal direction, two of these joints being interconnected at an angle of 90 degrees in the vertical direction, and the remaining one joint being connected at an angle of 45 degrees relative to one of said two joints and wherein a pipe member is inserted and adhered into each joint to form a pipe assembly consisting of straight, 45-degree bent and horizontal pipes.

9. A pipe coupling comprising four joints each having a diameter substantially equal to an internal diameter of a pipe member to be coupled, two of these joints extending in the straight line, one of the remaining two joints being connected at an angle 90 degrees relative to said straight line, and the other of the remaining two joints being connected at an angle of 45 degrees relative to said straight line and wherein a pipe member is inserted and adhered into each joint to form a pipe assembly consisting of straight, 45-degree bent and horizontal pipes.

10. A pipe coupling comprising two joints each having a diameter substantially equal to an internal diameter of a pipe member to be coupled, one of these joints extending in the straight line while the other joint being connected with the one joint at an angle of 135 degrees relative to said straight line and wherein a pipe member is inserted and adhered into each joint to form a 135-degree bent pipe.

11. A pipe coupling comprising three joints each having a diameter substantially equal to an internal diameter of a pipe member to be coupled, one of these joints extending in the straight line of the horizontal direction, another joint being connected with the one joint at an angle of 135 degrees relative to said straight line, and the remaining joint being connected with the above-mentioned joints at an angle of 90 degrees in the vertical direction and wherein a pipe member is inserted and adhered into each joint to form a pipe assembly consisting of 135-degree bent and horizontal pipes.

12. A pipe coupling comprising five joints each having a diameter substantially equal to an internal diameter of a pipe member to be coupled, two of these joints extending in the straight line of the horizontal direction, one of the remaining two joints extends with an angle 90 degrees relative in said straight line of said horizontal direction while the other joint extends with an angle of 45 degrees relative to said straight line and the final joint being connected with the above-mentioned joints at an angle of 90 degrees relative to the horizontal plane in the vertical direction and wherein a pipe member is inserted and adhered into each joint to form a pipe assembly consisting of straight, 45-degree bent, horizontal and vertical pipes.

13. A pipe coupling having a portion for connecting a rainwater protection member, a dust protection member or a lighting member.

14. A pipe coupling having a portion for fixing a corner of a pipe member.

15. A pipe coupling comprising four joints each having a diameter substantially equal to an internal diameter of a pipe member to be coupled, one of these joints extending in the horizontal plane of the horizontal direction, two of these joints extending in the straight line in the vertical direction, and the remaining one joint being connected at an angle of 90 degrees relative to said straight line and wherein a pipe member is inserted and adhered into each joint to form a pipe assembly consisting of straight, 90-degree bent and horizontal pipes.

16. A pipe coupling comprising two or more joints into each of which the corresponding one of two or more pipe members different in internal diameter from each other is inserted and adhered.
